(19) United States
(12) Patent Application Publication
(10) Pub. No.: US 2008/0215728 A1
(43) Pub. Date: Sep. 4, 2008

(54) Computer Management System and Computer Management Method

(75) Inventors: Zhanhai Li, Beijing (CN); Ke Ke, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: LENOVO (BEIJING) LIMITED, Beijing (CN)

(21) Appl. No.: 12/090,549

(22) PCT Filed: Mar. 24, 2006
(86) PCT No.: PCT/CN2006/000496

§ 371 Date: Apr. 17, 2008

(30) Foreign Application Priority Data
Oct. 20, 2005 (CN) 200510114302.2

(51) Int. Cl. G06F 15/173

(52) U.S. Cl. 709/224

(57) ABSTRACT

A computer management system and a computer management method are provided. The computer management system comprises a management workstation and at least one computer system based on virtualization technology. The computer system comprises a virtual machine monitor, a servo operating system, a management agent module and at least one user operating system. The management workstation comprises a detection/recognition module, an information collection module and a configuration module. The centralized management on the computer system by the management workstation can be realized through the management agent module establishing a network connection and communicating with the management workstation.

### BACKGROUND OF THE INVENTION

1. Field of Invention

The present invention relates to a computer management system and a computer management method, in particular to a computer management system and a computer management method based on virtualization technology.

2. Description of Prior Art

Management of computers has become an important issue with the popularization of computers. Demands from corporate, educational and high-security users include enhancement of the access control on a computer device and a port, restriction on network access, authorization of disk recording and even hard disk copying as well as centralized management of computers within certain scope.

The existing management methods for a computer device and a port are primarily achieved with the change of hardware and addition of management software, in which some methods for managing a computer device and a port through the change of hardware adopt the following schemes:

1. physical changes, such as pasting a seal to USB interface or floppy drive;
2. resetting BIOS;
3. resetting EFI;
4. setting up through a main board management controller.

Computer management with software is implemented mainly by adding management software to the operating system. The management software is used to enable access control on computer hardware device and port as well as to perform other types of management as demanded.

The schemes listed above have the following disadvantages.

Regarding the physical method of item 1, it is inconvenient to turn on and off the port access control, since this method can be implemented on only a single machine and is not capable of management and monitoring. Users can handle it at their own will, such as tearing off the seal.

Regarding the BIOS setting of item 2, this method can be implemented on only a single machine and is not capable of management and monitoring. Further. A user can enter a setup interface and make any modification at his or her own will. The status of port access can only be checked manually other than automatic monitoring.

The EFI setting of item 3, although management can be made via network, cannot be monitored. A user may enter a management interface to make any settings at his or her own will.

As to providing a management controller on the main board as mentioned in the above item 4, all main boards are not always equipped with such management controller, though this method is enabled with network management.

The above four schemes, all of which are at the hardware level, can realize the control on hardware device and port, while no other management can be enabled.

Although it can implement remote management, the method of adding management software to the operating system cannot guarantee the protection of such management software from any damage or invalidation, since the user can run the operating system at his or her own will.

Meanwhile, further development of the computer has the tendency of virtualization technology, which enables one computer to support a plurality of operating systems simultaneously.

Thus, it is desirable to provide a computer management system and a computer management method based on virtualization technology, which can conduct centralized management on the computers based on virtualization technology over a network.

### SUMMARY OF THE INVENTION

An object of the present invention is to provide a computer management system.

Another object of the present invention is to provide a computer management method.

A computer management system comprises a management workstation and at least one computer system based on virtualization technology, in which

the computer system comprises:
a virtual machine monitor for monitoring, managing and allocating computer devices or ports in a real-time manner;
a management agent module disposed between the virtual machine monitor and the management workstation and adapted for communication between the virtual machine monitor and the management workstation;
   the management workstation comprises:
a detection/recognition module for detecting and recognizing the management agent module over a network;
an information collection module for collecting information and/or request from the management agent module and forwarding it to a configuration module;
a configuration module for generating corresponding management control information based on information and/or request from the computer system and sending it to the management agent module over the network.

A computer management method for centralized management on a computer system in the computer management system as defined in claim 1 comprises steps of:
Step 1, detecting and recognizing a management agent module by a detection/recognition module, and establishing a network connection between the computer system and a management workstation;
Step 2, real-time monitoring computer devices or ports by a virtual machine monitor;
Step 3, sending, by the management agent module, information and/or request related to the computer devices or ports to the management workstation;
Step 4, collecting, by an information collection module, the information and/or request related to the computer devices or ports, generating, by a setting module, management control information based on the information and/or request and sending to the management agent module;
Step 5, managing and allocating the computer devices or ports by the virtual machine monitor based on the management control information.

With the present invention, the following advantages can be achieved.

1) Management is facilitated since the access control of computer devices or ports is realized through parameter setting by the virtual machine monitor.
2) The virtual machine monitor always runs at the underlying layer of the computer system and monitors the statuses of the devices and ports in a real-time manner.
3) The ports can be opened or closed remotely, and the port access can be monitored in the form of network centralized management.
4) Only the administrator, other than ordinary users, has access to the virtual machine monitor, and thus the centralized management of the computer system by the management workstation cannot be evaded.

Therefore, the computer management system and management method can well meet the demand of centralized management on computers from corporate, educational and high-security users.

### BRIEF DESCRIPTION OF THE DRAWINGS

FIG. 1 shows a computer management system for centralized management of computers based on virtualization technology according to the present invention;

FIG. 2 shows a flowchart of the operation of computer system 2;

FIG. 3 shows a flowchart of the operation of management workstation 1; and

FIG. 4 shows a flowchart of the operation of the computer management system according to the present invention.

### DETAILED DESCRIPTION OF PREFERRED EMBODIMENTS

Below, the centralized computer management system and the computer management method of the present invention will be explained with reference to the figures.

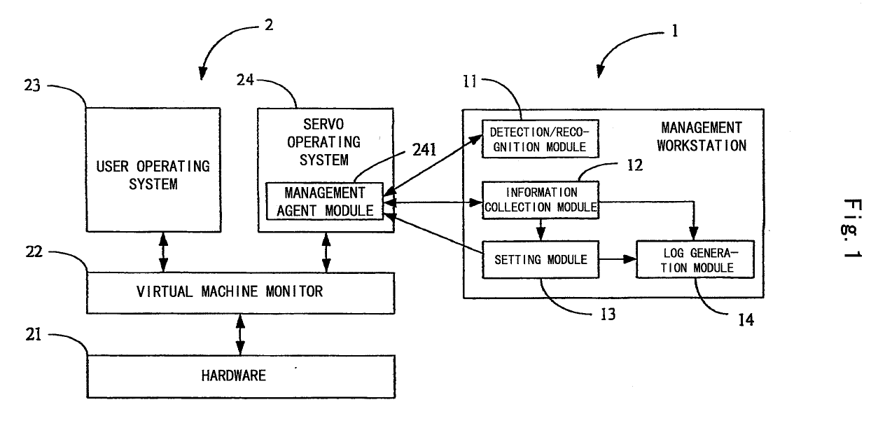

FIG. 1 shows a computer management system for centralized management of computers based on virtualization technology according to the present invention. This computer management system comprises one management workstation 1 and at least one computer system 2 based on virtualization technology. In the present invention, each of the computer system 2 communicates with the management workstation 1 in the same way, and thus only one computer system is illustrated in FIG. 1 for the purpose of concise description.

The management workstation 1 includes a detection/recognition module 11, an information collection module 12 and a configuration module 13. To facilitate the analysis and management of administration personnel, the management workstation 1 can further include a log generation module 14. The management workstation 1 can impose a centralized management on the computer system 2 in two fashions of active and passive management.

The computer system 2 includes hardware 21, a virtual machine monitor 22, at least one user operating system 23 and a servo operating system 24. The virtual machine monitor 22 is installed above the hardware and virtualizes the latter. The virtual machine monitor 22 also manages the access and use of the user operating system 23 installed above it to the hardware 21.

To allow the management workstation 1 to manage access to the computer devices and ports in the computer system 2, one management agent module 241 is further provided in the servo operating system 24, and it can communicate with the management workstation 1 over a network. With the communication with the management workstation 1 through the management agent module 241, it is possible to implement centralized management on the computer system 2 by the management workstation 1.

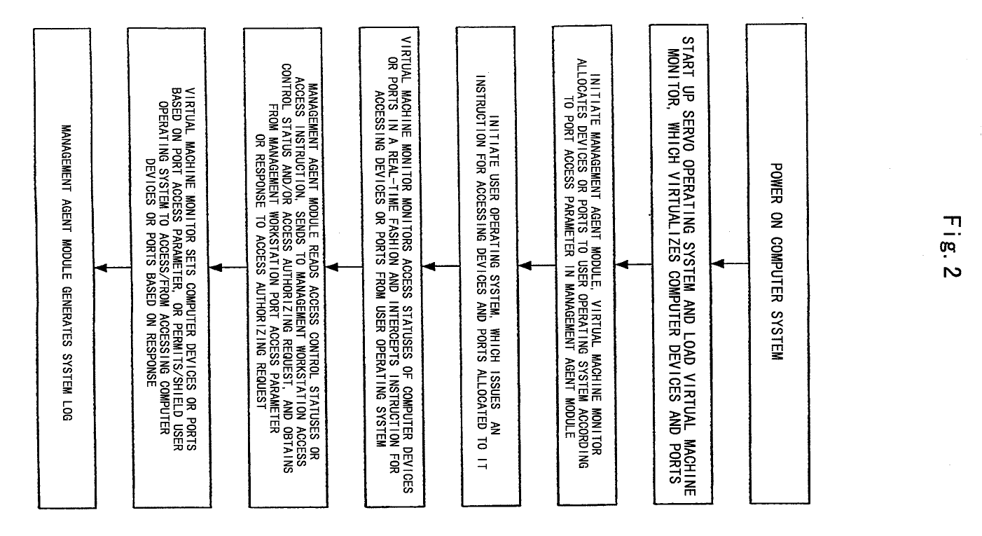

FIG. 2 shows a flowchart of the operation of the computer system 2, which comprises particularly the steps of:

Step 1, powering on the computer system 2;
Step 2, starting up the servo operating system 24 and loading the virtual machine monitor 22, which virtualizes the computer devices and ports;
Step 3, initiating the management agent module 241; the virtual machine monitor 22 allocates a device or a port to the user operating system 23 according to the port access parameter in the management agent module 241; the port access parameter can be a parameter set in advance so that the user operating system can conduct access operations, or be the port access parameter stored after the last operation;
Step 4, initiating the user operating system 23, which issues an instruction for accessing the device and the port allocated to it;
Step 5, the virtual machine monitor 22 monitors the access statuses of the computer devices or the ports in a real-time fashion and intercepts the instruction for accessing the devices or the ports from the user operating system 23;
Step 6, the management agent module 241 reads regularly, from the virtual machine monitor 22, the access control statuses of the computer devices or the ports or the instruction for accessing the computer device or the ports from the user operating system 23; then, it sends to the management workstation 1 the access control status and/or the access authorizing request, which is generated in accordance with the access instruction, obtains from the management workstation 1 the port access parameter corresponding to the access control status or the response to the access authorizing request, and then sends the parameter or the response to the virtual machine monitor 22;
Step 7, the virtual machine monitor 22 sets the computer devices or the ports accessible by the user operating system 23 based on the port access parameter, or permits/shields the user operating system 23 to access or from accessing the computer devices or the ports based on the response.

The management agent module 241 further generates a system log in order to facilitate the local management of the computer system 2.

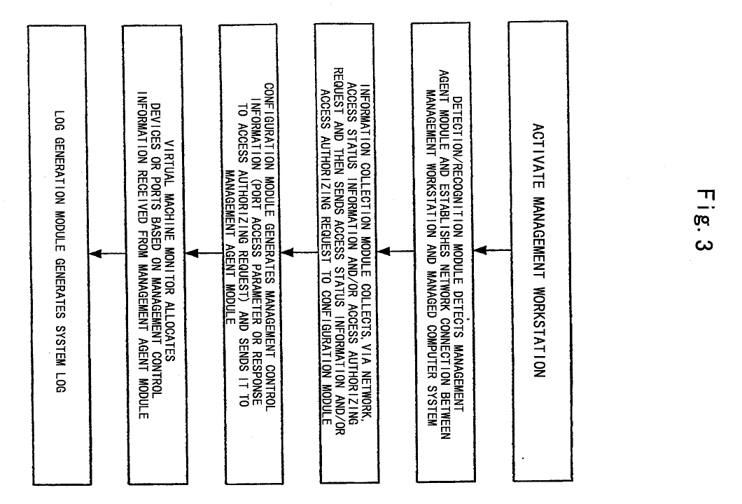

FIG. 3 is a flowchart of the operation of the management workstation, which comprises the steps of:

Step a, activating the management workstation 1;
Step b, the detection/recognition module 11 finds the management agent module 241 via the network and establishes the network connection between the management workstation 1 and the managed computer system 2;
Step c, the information collection module 12 may collect, via the network, the access status information on the computer devices or the ports and/or the access authorizing request sent from the management agent module 241, and then send the access status information and/or the access authorizing request to the configuration module 13;
Step d, the configuration module 13 may, on one hand, based on the access control status information, set the port access parameter of the managed device by means of strategy, the stored access control parameter, manual setting or the like, and send the set port access parameter to the management agent module 241; on the other hand, the configuration module 13 may, based on the access status information and the access authorizing request, response (permit or shield access) to the access authorizing request by means of strategy or the stored access control parameter, and then send the response to the management agent module 241;
Step e, the virtual machine monitor 22 allocates the devices or the ports to the user operating system 23 based on the port access control parameter received from the management agent module 241, or permits or shields the user operating system 23 to access and operate or from accessing and operating the allocated computer devices or the ports based on the response received from the management agent module 241. In this way, the management workstation 1 accomplishes the control over the access of the user operating system to the devices or the ports.

Further, the information collection module 12 can send the access status information and/or the access authorizing request to the log generation module 14. Meanwhile, the configuration module 13 can send the port access parameter or the response to the access authorizing request to the log generation module 14, and thus the log generation module 14 may generate the corresponding log based on the information on port access status from the information collection module 12 and the port access parameter or the response to the access authorizing request from the configuration module 13.

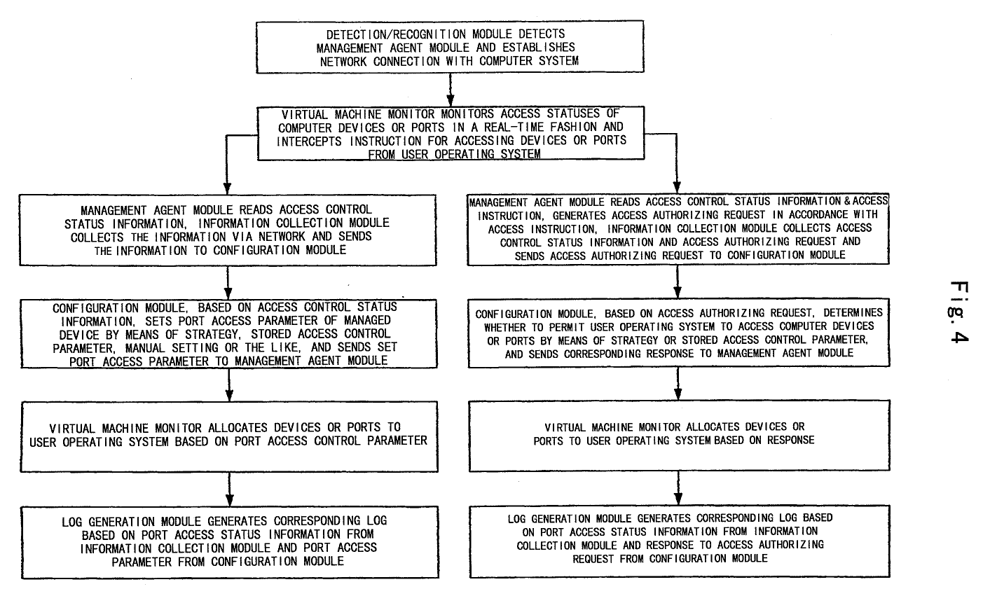

For the purpose of a clear understanding of the present invention, FIG. 4 is referred to, which is an operational flowchart of the computer management system of the present invention.

After the management workstation 1 is initiated and the computer system 2 activates the user operating system 23, the detection/recognition module 11 in the management workstation 1 detects the management agent module 241 and thus establishes the network connection with the computer system 2.

In the computer system 2, the virtual machine monitor 22 monitors the access statuses of the computer devices or the ports in a real-time fashion and intercepts the instruction for accessing the computer devices or the ports from the user operating system 23. Since the subsequent operation flow varies for two modes of active management mode and passive management mode, explanation of the subsequent operation flow will be given to each of the two management modes, respectively.

i) In the active management mode, the management agent module 241 reads regularly, from the virtual machine monitor 22, the access control statuses of the computer devices or the ports; the information collection module 12 in the management workstation 1 collects the information on access control status via the network and sends the information on access control status to the configuration module 12.

The configuration module 13, based on the access control status information, sets the port access parameter of the managed device by means of strategy, the stored access control parameter, manual setting or the like, and sends the set port access parameter to the management agent module 241.

The virtual machine monitor 22 allocates the devices or the ports to the user operating system 23 based on the port access control parameter received from the management agent module 241. Here, these computer devices or ports can be the same as or different from those upon the initialization of the user operating system. In this way, the management workstation 1 accomplishes the control over the access of the user operating system to the devices or the ports.

Further, the information collection module 12 may send the access status information to the log generation module 14. Meanwhile, the configuration module 13 may send the port access parameter to the log generation module 14, and thus the log generation module 14 may generate the corresponding log based on the information on port access status from the information collection module 12 and the port access parameter from the configuration module 13.

ii) In the passive management mode, the management agent module 241 reads regularly, from the virtual machine monitor 22, the access control status information of the computer devices or the ports as well as the instruction for accessing the computer device or the ports from the user operating system 23, generates the access authorizing request in accordance with the access instruction, and sends to the management workstation 1 the access control status information and the access authorizing request; the information collection module 12 collects the access control status information and the access authorizing request via the network and sends the access authorizing request to the configuration module 12.

The configuration module 13, based on the access authorizing request, determines whether or not to permit the user operating system 23 to access (all or part of the computer devices or the ports by means of strategy or the stored access control parameter, and sends the corresponding response (access right) to the management agent module 241.

The virtual machine monitor 22 allocates the devices or the ports to the user operating system 23 based on the response received from the management agent module 241. In this way, the management workstation 1 accomplishes the control over the access of the user operating system to the devices or the ports.

Further, the information collection module 12 may send the access status information to the log generation module 14. Meanwhile, the configuration module 13 may send the response to the access authorizing request to the log generation module 14, and thus the log generation module 14 may generate the corresponding log based on the information on port access status from the information collection module 12 and the response to the access authorizing request from the configuration module 13.

As described above, by providing the management agent module 241 in the computer system 2, the management workstation may obtain the access control statues of the computer devices or ports in the computer system 2 as well as the instruction for accessing the computer devices or ports from the user operating system 23, and thus can implement a centralized control over the access of the user operating system to the computer devices or ports strategically or based on the stored access control parameter or the response to the access authorizing request from the management agent module 241.

Therefore, the present invention has the following advantages.

1) Management is facilitated since the access control of computer devices or ports is realized through parameter setting by the virtual machine monitor 22.
2) The virtual machine monitor 22 always runs at the underlying layer of the computer system and monitors the statuses of the devices and ports in a real-time manner.
3) The ports can be opened or closed remotely, and the port access can be monitored in the form of network centralized management.
4) Only the administrator, other than ordinary users, has access to the virtual machine monitor 22, and thus the centralized management of the computer system by the management workstation cannot be evaded.

Therefore, the computer management system and management method can well meet the demand of centralized management on computers from corporate, educational and high-security users.

In the previous embodiment, the management agent module 241 is provided in the servo operating system 24. Similarly, it can be provided in the virtual machine monitor 22 or as a separate module that is independent of the servo operating system and the virtual machine monitor 22.

Further, in the previous embodiment, the computer management system and the management method are illustrated only by example of the access from the user operating system 23 to the computer devices or the ports. It will be understood that the computer management system and the management method can also be applied to any other similar mechanism for imposing a centralized management on the computer system.

The present invention is not limited to the above particular embodiments. Any apparent modifications, changes or substitutions made by those skilled in the art after reading the present application should fall into the scope of the system and method in the appended claims.

1. A computer management system comprising a management workstation and at least one computer system based on virtualization technology, wherein the computer system comprises:
a virtual machine monitor for real-time monitoring, managing and allocating
computer devices or ports; and
a management agent module disposed between the virtual machine monitor and the management workstation and adapted for communication between the virtual machine monitor and the management workstation;
the management workstation comprises:
a detection/recognition module for detecting and recognizing the management agent module over a network;
an information collection module for collecting information and/or request from the management agent module and forwarding it to a configuration module; and
a configuration module for generating corresponding management control information based on information and/or request from the computer system and sending it to the management agent module over the network.

2. The computer management system of claim 1, wherein the computer system further comprises at least one user operating system,
the virtual machine monitor monitors the access control statues of the computer devices or ports in a real-time fashion, intercepts the instruction for accessing the computer devices or ports from the user operating system, and allocates the computer devices or ports to the user operating system based on the management control information from the management agent module for the access from the user operating system to the computer devices or ports.

3. The computer management system of claim 1, wherein the management agent module establishes a network connection with the management workstation over the network, reads the access control status information and/or access instruction from the virtual machine monitor, sends to the management workstation the access control status information and/or the access authorizing request corresponding to the access instruction, and sends the management control information received from the management workstation to the virtual machine monitor.

4. The computer management system of claim 2, wherein the management agent module sends to the management workstation the access control status information read from the virtual machine monitor; the information collection module collects the access control status information and sends it to the configuration module; the configuration module, based on strategy, the stored access control parameter or manual operation, sets corresponding access control parameter for the received access control status information and sends it to the management agent module; the virtual machine monitor allocates the computer devices or ports to the user operating system based on the access control parameter from the management agent module.

5. The computer management system of claim 4, wherein the management workstation further comprises a log generation module; the information collection module further sends the collected access control status information to the log generation module, and the configuration module sends the set access control parameter to the log generation module by which a management log is generated for the management workstation.

6. The computer management system of, claim 1 wherein the management agent module further generates a system log.

7. The computer management system of claim 2, wherein the management agent module sends to the management workstation the access control status information and the access authorizing request corresponding to the access instruction; the information collection module collects the access control status information and the access authorizing request and sends the access authorizing request to the configuration module; the configuration module, based on strategy or the stored access control parameter, sets corresponding response to the received access authorizing request and sends the response to the management agent module; the virtual machine monitor allocates the computer devices or ports to the user operating system based on the access control parameter from the management agent module.

8. The computer management system of claim 7, wherein the management workstation further comprises a log generation module; the information collection module further sends the collected access control status information to the log generation module, and the configuration module sends response to the access authorizing request to the log generation module by which a management log is generated for the management workstation.

9. The computer management system of, claim 7 wherein the management agent module further generates a system log.

10. A computer management method for implementing centralized management on a computer system in the computer management system of claim 1, comprising
steps of:
Step 1, detecting and recognizing a management agent module by a detection/recognition module, and establishing a network connection between the computer system and a management workstation;
Step 2, real-time monitoring computer devices or ports by a virtual machine monitor;
Step 3, sending, by the management agent module, information and/or request related to the computer devices or ports to the management workstation;
Step 4, collecting, by an information collection module, the information and/or request related to the computer devices or ports, generating, by a setting module, management control information based on the information and/or request and sending it to the management agent module;
Step 5, managing and allocating the computer devices or ports by the virtual machine monitor based on the management control information.

11. The computer management method of claim 10, wherein the computer system further comprises at least one user operating system,
Step 2 further comprises the sub-steps of:
the virtual machine monitor monitors the access control statues of the computer devices or ports in a real-time fashion, intercepts the instruction for accessing the computer devices or ports from the user operating system;
Step 5 further comprises the sub-steps of:
the virtual machine monitor allocates the computer devices or ports to the
user operating system based on the management control information from the management agent module for the access from the user operating system to the computer devices or ports.

12. The computer management method of claim 10, wherein
Step 3 further comprises the sub-steps of:
the management agent module establishes a network connection with the management workstation over the network, reads the access control status information and/or access instruction from the virtual machine monitor and
sends to the management workstation the access control status information and/or the access authorizing request corresponding to the access instruction;
Step 4 further comprises the sub-steps of:
the management agent module sends the management control information received from the management workstation to the virtual machine monitor.

13. The computer management method of claim 10, wherein
between Steps 4 and 5 or after Step 5, the method further comprises generating a management log for the management workstation based on the information related to the computer devices or ports and the management control information.

14. The computer management method of claim 10, wherein
after Step 5, the method further comprises generating a system log by the management agent module.

15. The computer management method of claim 10, wherein
when the information read and sent by the management agent module at Step 3 is access control status information, the management control information is access control parameter set by the setting module based on strategy, the stored access control parameter or manual operation.

16. The computer management method of claim 10, wherein
when the information read and sent by the management agent module at Step 3 is access control status information and access authorizing request, the management control information is a response to the access authorizing request set by the setting module based on strategy or the stored access control parameter.
